(19) United States
(12) Patent Application Publication
(10) Pub. No.: US 2017/0245960 A1
(43) Pub. Date: Aug. 31, 2017

(54) ENDODONTIC HANDPIECE WITH ROTATIONAL AND VERTICAL MOTION

(71) Applicant: Matthew GHADAMI, Roslyn Heights, NY (US)

(72) Inventor: Matthew GHADAMI, Roslyn Heights, NY (US)

(21) Appl. No.: 15/515,877

(22) PCT Filed: Sep. 30, 2015
(86) PCT No.: PCT/US2015/053174

§ 371 Date: Mar. 30, 2017

Related U.S. Application Data
(60) Provisional application No. 62/057,435, filed on Sep. 30, 2014.

(51) Int. Cl. A61C 5/42; A61C 1/14; A61C 1/02

(52) U.S. Cl. CPC A61C 5/42; A61C 1/02; A61C 1/141

(57) ABSTRACT

An endodontic handpiece including a handpiece body defining a neck portion extending to a head portion which defines a chamber with an opening therefrom. A chalk is positioned in the chamber and includes a cylindrical body having a longitudinal axis, a retainer for holding an endodontic tool co-axially with the cylindrical body, and a pin receiving bore defined in the cylindrical body transverse to the longitudinal axis. A shaft is rotatably supported within the neck portion and having a pin extending from an end thereof and received in the pin receiving bore of the chalk. The pin is offset from a central axis of the shaft such that rotation of the shaft causes the chalk to move downwardly, rotate in a clockwise direction, move upwardly and rotate in a counter-clockwise direction over each 360° rotation of the shaft.

### CROSS-REFERENCE TO RELATED APPLICATIONS

This application claims the priority to U.S. Provisional Patent Application No. 62/057,435, filed Sep. 30, 2014, the disclosure of which is incorporated herein by reference.

### FIELD OF THE INVENTION

This invention relates to a handpiece for endodontic treatment. More particularly, the invention relates to an endodontic handpiece configured to provide rotational and vertical motion of an endodontic file.

### BACKGROUND OF THE INVENTION

Endodontic treatment, also referred to as root canal treatment, treats the inside of the tooth. Endodontic treatment is necessary when the pulp becomes inflamed or infected. If pulp inflammation or infection is left untreated, it can cause pain or lead to an abscess.

During root canal treatment, the inflamed or infected pulp is removed and the inside of the tooth is carefully cleaned, shaped and disinfected, then filled and sealed with a rubber-like material called gutta-percha. Afterwards, the tooth is restored with a crown or filling for protection. After restoration, the tooth continues to function like any other tooth.

Cleaning and shaping of the root canal is an important element of the endodontic treatment procedure. Its final objective is to achieve an apically tapered preparation which will facilitate the progressive access of irrigating solutions into areas within the root canal system. The procedure generally includes three mechanical steps, namely, debridement, shaping and cleansing. Debridement is a procedure where the nerve tissues are removed from the canals. Shaping is a procedure where the inner walls of the canals are shaped to a smooth path ready for obturation. Cleansing is a procedure where the deposits of nerve tissue and bits and pieces of canal walls are taken out of the canal.

Typically these mechanical steps are achieved with the use of hand files and/or rotary instruments. The hand files facilitate a vertical, reciprocating motion within the canal while the rotary instruments provide a rotational drilling motion. The multiple steps and switching between instruments causes a relatively lengthy procedure.

### SUMMARY OF THE INVENTION

In at least embodiment, the present invention provides an endodontic handpiece including a handpiece body defining a neck portion extending to a head portion which defines a chamber with an opening therefrom. A chalk is positioned in the chamber and includes a cylindrical body having a longitudinal axis, a retainer for holding an endodontic tool co-axially with the cylindrical body, and a pin receiving bore defined in the cylindrical body transverse to the longitudinal axis. A shaft is rotatably supported within the neck portion and having a pin extending from an end thereof and received in the pin receiving bore of the chalk. The pin is offset from a central axis of the shaft such that rotation of the shaft causes the chalk to move downwardly, rotate in a clockwise direction, move upwardly and rotate in a counter-clockwise direction over each 360° rotation of the shaft.

In another aspect, the invention provides a chalk for an endodontic handpiece. The chalk includes a cylindrical body having a longitudinal axis, a retainer for holding an endodontic tool co-axially with cylindrical body, and a pin receiving bore defined in the cylindrical body transverse to the longitudinal axis.

In yet another aspect, the invention provides a file for an endodontic handpiece including a chalk. The file includes a handle portion configured to be held in the chalk and a file body manufactured from a material which provides shape memory and elasticity.

In another aspect, the invention provides a method of removing tissue from the root canal comprising inserting into a root canal a an endodontic operative handpiece including a chalk as previously described, which will conform to the contour of a root canal upon insertion, wherein tissue is efficiently removed from the root canal.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a side elevation view of an exemplary handpiece in accordance with an embodiment of the invention.

FIG. 2 is a bottom perspective view of the handpiece of FIG. 1.

FIG. 3 is a cross-sectional view of the handpiece of FIG. 1 with the chalk in a top most position.

FIG. 4 is a cross-sectional view similar to FIG. 3 with the chalk in a bottom most position.

FIG. 5 is a perspective view of an exemplary shaft in accordance with an embodiment of the invention.

FIG. 6 is a perspective view of an exemplary chalk in accordance with an embodiment of the invention.

FIG. 7 is a side elevation view of an exemplary file in accordance with an embodiment of the invention.

FIG. 8 is a perspective view of the exemplary chalk schematically illustrating the path of motion of the chalk.

FIGS. 9A, 9B, 9C, 9D, 9E, 9F, 9G, 9H, 9I, 9J, 9K and 9L are schematic views of the shaft and chalk illustrating motion of the chalk over one rotation of the shaft.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

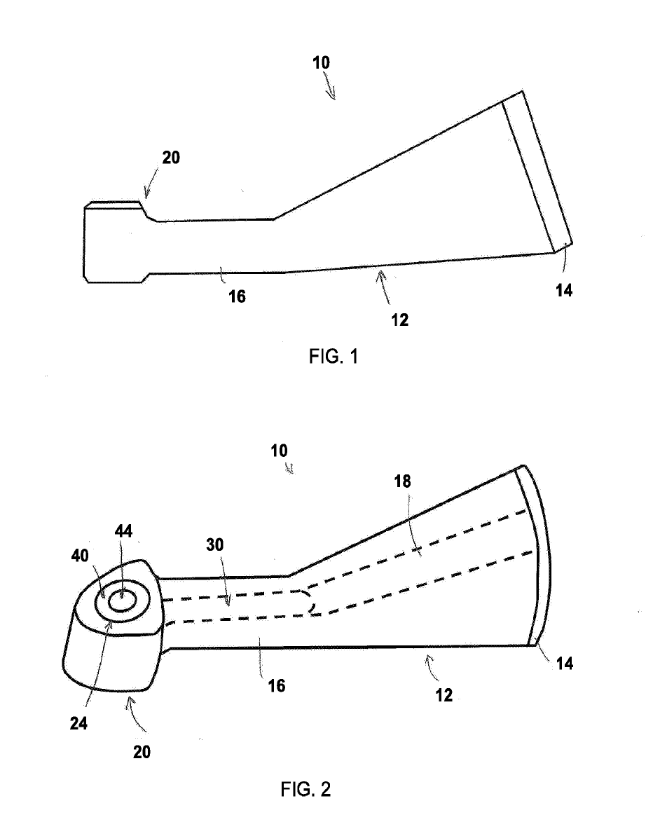

Referring to FIGS. 1-8, an exemplary endodontic handpiece 10 in accordance with an embodiment of the invention will be described. The handpiece 10 includes a housing or body 12 extending from a connection end 14 to a head 20. The connection end 14 is configured for connection to a power supply, a motor housing, gas or liquid supplies and the like as is known in the art. The head 20 defines a chamber 22 configured to receive a chalk 40 as described hereinafter. An opening 24 is provided in the head 20 such that a file 50 or other tool held by the chalk 40 may extend from the head 20.

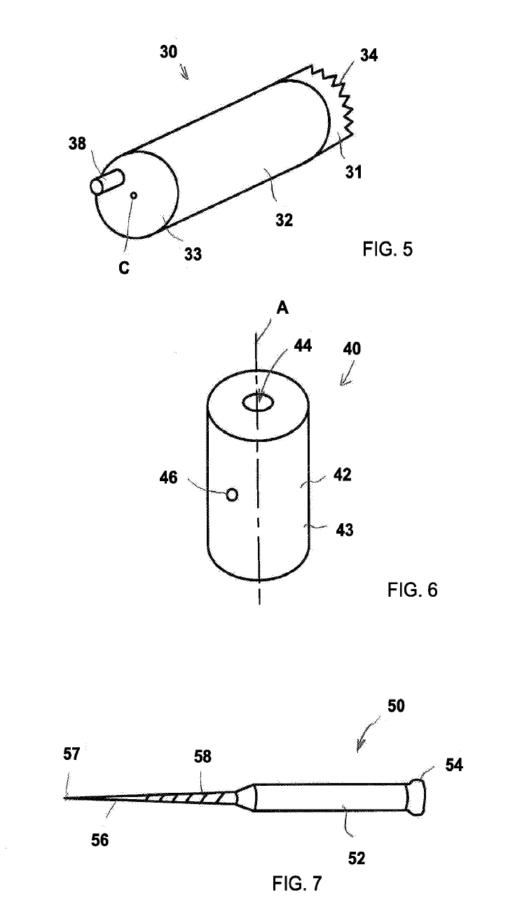

Referring to FIGS. 2-5, a rotating shaft 30 extends in a neck portion 16 of the body 12. The shaft 30 includes a cylindrical body 32 supported at opposite ends 31, 33 by bearings 36a, 36b or the like. The rearward end 31 of the shaft body 32 includes a gear 34 or the like configured to directly, or through a jack 18 or the like, engage a motor output shaft (not shown) such that rotation of the motor output shaft causes the shaft 30 to rotate about a center axis C. The forward end 33 of the shaft body 32 includes a chalk engaging pin 38 extending therefrom. As illustrated in FIG. 5, the pin 38 is offset from the center axis C such that it provides an eccentric motion to the chalk 40 as described hereinafter.

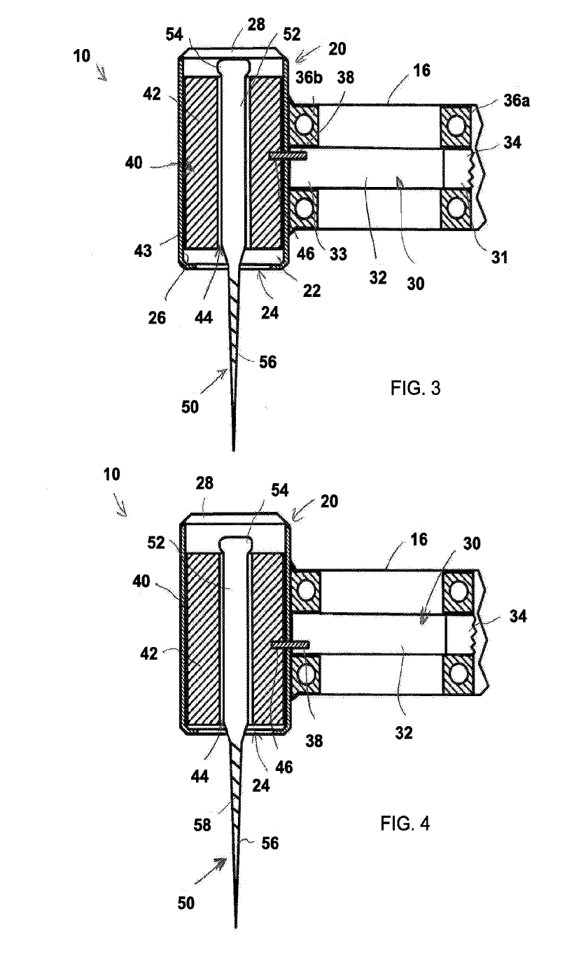

Referring to FIGS. 3-4 and 6-7, the chalk 40 has a generally cylindrical body 42 with a longitudinal axis A. A tool receiving bore 44 extends through the cylindrical body 42 coaxially therewith. The cylindrical body 42 is sized such that an outer surface 43 thereof engages an inner surface 26 of the head 20 such that the chalk 40 is piloted for rotational and longitudinal motion within the chamber 22 of the head 20. The chamber 22 has a length greater than the height of the cylindrical body 42 such that the chalk 40 may longitudinally reciprocate within the chamber 22 over a limited distance, as will be described in more detail hereinafter. The tool receiving bore 44 is preferably coaxial with the opening 24 in the head 20. The chalk body 42 also defines a pin receiving bore 46 extending generally transverse to the longitudinal axis A. The bore 46 is configured to receive the chalk engaging pin 38 extending from the rotating shaft 30.

The exemplary file 50 includes a handle portion 52 with a head 54 at one end and a file body 56 extending from the opposite end. The handle portion 52 preferably has an outer diameter which is approximately equal to the inner diameter of the tool receiving bore 44 and the head 54 is slightly larger than the diameter of the handle portion 52. The handpiece head 20 may include a removable cap 28 to facilitate changing of the file 50 relative to the chalk 40. The handle portion 52 and the head 54 are preferably manufactured from rubber or another natural or synthetic elastomeric material such that the file 50 is firmly held firmly within the chalk 40.

The file body 56 may have various configurations. In the illustrated embodiment, the file body 56 extends to a pointed tip 57 and has a plurality of threads 58. The file body 52 is preferably manufactured from nickel titanium or a similar material which provides shape memory and elasticity. The combined rotational and reciprocal motions, as described in greater detail hereinafter, provide a greater operating force and thereby allow the use of such material rather than more rigid materials typically found in endodontic files. The motion and the elastic nature of the file body 52 allows the files 50 to be utilized whether it is a calcified or non-calcified canal, narrow or wide canal, curved or twisted canal, or a 90° or more bend at the apices of the canals, to name a few examples. It is recognized that the files 50 may have different configurations. It is also recognized that the chalk 40 may have different configurations for holding the files.

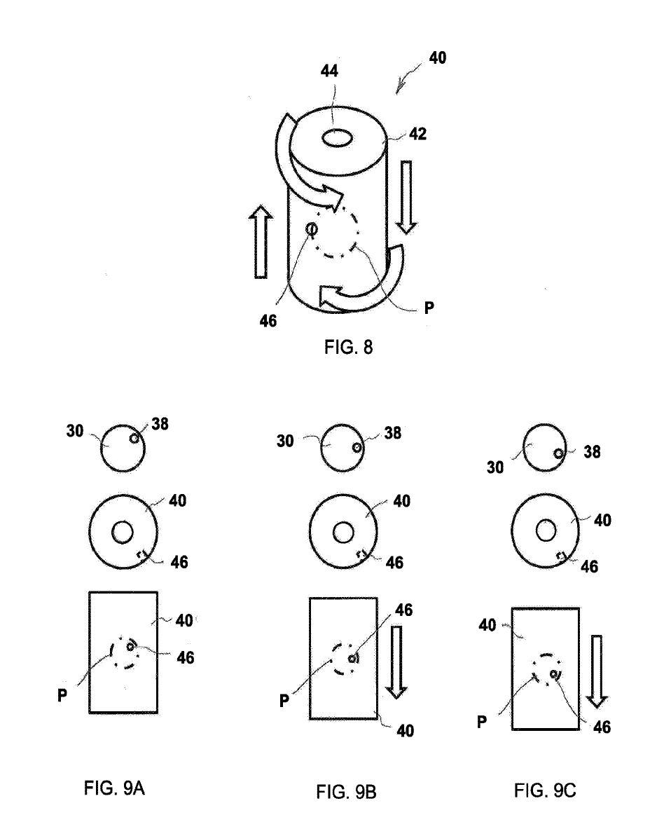

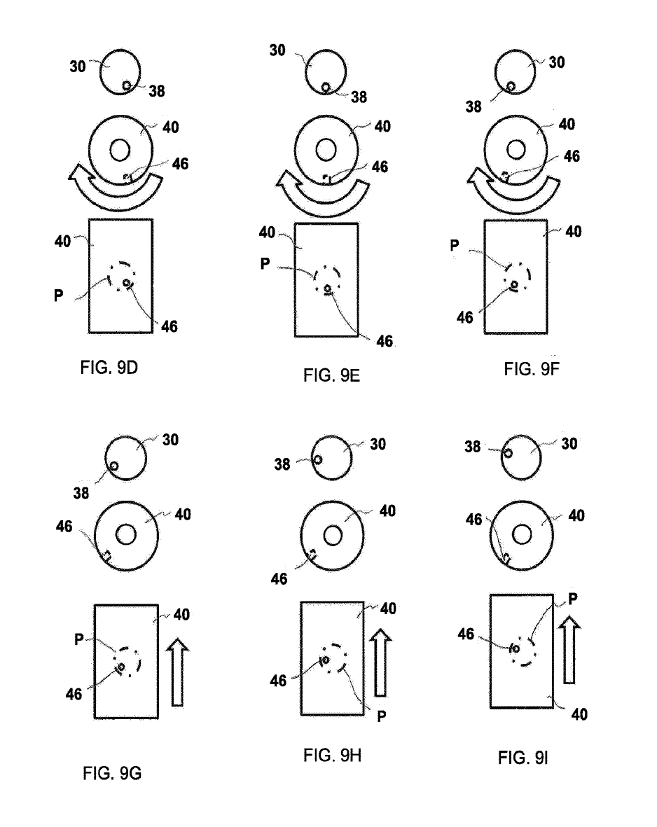

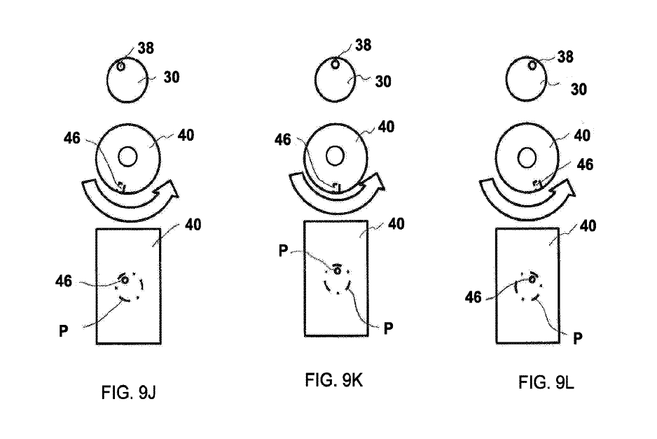

Having described the components of the exemplary endodontic handpiece 10, motion of the chalk 40 and associated file 50 will be described with respect to FIGS. 8-9L. As the pin 38 of the shaft 30 rotates in a circular motion, the pin receiving bore 46 moves in a corresponding circular path P. Since the chalk 40 is positioned within the head chamber 22 and restricted from transverse motion, movement of the pin 38 and, resultant following by the bore 46, in a circular path P causes the chalk 40 to move downward, rotate clockwise, move upward, and rotate counter-clockwise over each 360° rotation of the shaft 30. Generally speaking, the chalk 40 moves downward as the pin 38 moves from 12 o'clock to 6 o'clock and upwardly as the pin 38 moves from 6 o'clock to 12 o'clock. Additionally, the chalk 40 rotates in the clockwise direction as the pin 38 moves from 3 o'clock to 9 o'clock pin and rotates in a counter-clockwise direction as the pin 38 moves from 9 o'clock to 3 o'clock. This concept is derived from the equation of the circle, (X−A)²+(Y−B)²=RA² to determine the differential movement of the chalk 40 relative to the pin 38.

FIGS. 9A-9L illustrate schematically the motion of the shaft 30 and the corresponding rotational and longitudinal motion of the chalk 40 over a 360° rotation of the shaft 30. It is noted that the chalk 40 is shown both in top view and plan view. Starting at 2 o'clock as illustrated in FIG. 9A, the shaft 30 rotates clockwise, causing the pin 38 to rotate to 3 o'clock and 4 o'clock as illustrated in FIGS. 9B and 9C, respectively. With this motion, there is relatively little rotational motion of the chalk 40 as the pin 38 remains in substantially the same vertical plane (although there is some minor change while the pin 38 generally moves vertically, thereby moving the chalk 40 downward as indicated by the arrows. This downward motion generally represents the shaping stage of the endodontic procedure.

Referring to FIGS. 9D-9F, the pin 38 continues to rotate from 5 o'clock to 7 o'clock. Over this range of motion, the pin 38 remains substantially in the same horizontal plane (although there is some minor change) while the pin 38 generally moves horizontally, thereby rotating the chalk 40 in the clockwise direction as indicated by the arrows. This clockwise rotation generally represents the debridement portion of the endodontic procedure.

Referring to FIGS. 9G-9I, the pin 38 continues to rotate from 8 o'clock to 10 o'clock. Over this range of motion, the pin 38 remains substantially in the same vertical plane (although there is some minor change) while the pin 38 generally moves vertically upward, thereby moving the chalk 40 upward as indicated by the arrows. This upward motion generally represents a further shaping portion of the endodontic procedure.

Referring to FIGS. 9J-9L, the pin 38 continues to rotate from 11 o'clock to 1 o'clock. Over this range of motion, the pin 38 remains substantially in the same horizontal plane (although there is some minor change) while the pin 38 generally moves horizontally, thereby rotating the chalk 40 in the counter-clockwise direction as indicated by the arrows. This counter-clockwise rotation generally represents the cleansing portion of the endodontic procedure.

It has been found that the automated, multicomponent movement provided by an endodontic handpiece in accordance with the invention can expedite a root canal procedure.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A chalk for an endodontic handpiece, the chalk comprising:
a cylindrical body having a longitudinal axis;
a retainer for holding an endodontic tool co-axially with cylindrical body; and
a pin receiving bore defined in the cylindrical body transverse to the longitudinal axis.

2. An endodontic handpiece comprising:
a handpiece body defining a neck portion extending to a head portion, the head portion defining an internal chamber with an opening therefrom;
a chalk positioned in the chamber, the chalk including a cylindrical body having a longitudinal axis, a retainer for holding an endodontic tool co-axially with the cylindrical body, and a pin receiving bore defined in the cylindrical body transverse to the longitudinal axis; and
a shaft rotatably supported within the neck portion, the shaft having a pin extending from an end thereof and received in the pin receiving bore of the chalk, the pin being offset from a central axis of the shaft such that rotation of the shaft causes the chalk to move downwardly, rotate in a clockwise direction, move upwardly and rotate in a counter-clockwise direction over each 360° rotation of the shaft.

3. A file for an endodontic handpiece including a chalk, the file comprising:
a handle portion configured to be held in the chalk; and
a file body manufactured from a material which provides shape memory and elasticity.

4. A method of removing tissue from the root canal comprising inserting into a root canal a device as described in claim 1, which will conform to the contour of a root canal upon insertion, wherein tissue is efficiently removed from the root canal.
